(19) United States
(12) Patent Application Publication
(10) Pub. No.: US 2014/0282865 A1
(43) Pub. Date: Sep. 18, 2014

(54) DYNAMIC H-SLP ALLOCATION FOR SET INITIATED SUPL SERVICES

(71) Applicant: QUALCOMM INCORPORATED, San Diego, CA (US)

(72) Inventor: Andreas Klaus Wachter, Menlo Park, CA (US)

(73) Assignee: QUALCOMM Incorporated, San Diego, CA (US)

(21) Appl. No.: 13/798,061

(22) Filed: Mar. 12, 2013

(51) Int. Cl. H04W 12/08

(52) U.S. Cl. CPC H04W 12/08
USPC 726/3

(57) ABSTRACT

Methods, systems, computer-readable media, and apparatuses for accessing services from multiple home Secure User Plane Location (SUPL) Platforms.(H-SLP) servers are provided. In one potential embodiment, a method describes identifying in an application identifier list, a fully qualified domain (FQDN) name associated with the application from a plurality of FQDNs. A subsequent request for services by a different application on the device may identify a different FQDN associated with a different H-SLP to provide services to the device for the second application.

### BACKGROUND

Aspects of the disclosure relate to computing technologies which enable location services. In particular, aspects of the disclosure relate to systems, methods, apparatus, and computer readable media for enabling access to a plurality of Secure User Plane Location (SUPL) Platform (SLP) servers for providing location services in conjunction with various applications running on a single device.

SUPL is a user plane technology that uses internet protocol technology to support location based services. The primary focus of SUPL is to provide and enhance location service using wireless communication. While there are a variety of ways to support positioning, SUPL does so by providing a standardized environment with a simple client server architecture.

In devices using SUPL services, the standard implementation involves devices with a fixed single home H-SLP allocation based on a pre-provisioned setting. A device uses the pre-provisioned setting, which is the H-SLP address, to establish a connection with the device's single H-SLP when engaging in a SUPL session. As devices, especially mobile devices, become more and more powerful and more and more capable of operating multiple applications concurrently and in multiple contexts, additional systems, methods, structures, and devices for implementing location services using different SLP servers may be desirable.

### BRIEF SUMMARY

Embodiments described herein related to the use of multiple H-SLP from a single device, in managing connections from devices to H-SLP on an application basis rather than on a device basis, and on similar such communication concepts.

For example, one potential embodiment includes a method comprising: initiating, by a first application operating on a secure user plane location enabled terminal (SET), a first request for secure user plane location (SUPL) service; identifying in an application identifier list, a first fully qualified domain name (FQDN) associated with the first application; and communicating, by the SET, the first request for SUPL service to a first H-SLP associated with the first FQDN. This method then further comprises initiating, by a second application operating on the SET, a second request for SUPL service; identifying in the application identifier list, a second FQDN associated with the second application, wherein the second FQDN is different than the first FQDN and wherein the application identifier list comprises the first FQDN and the second FQDN; and communicating, by the SET, the second request for SUPL service to a second H-SLP associated with the second FQDN.

Further embodiments of such a method may function where the first and the second FQDN are stored in a secure location on the SET, where the first and the second FQDN are stored on a universal integrated circuit card (UICC) used by the SET, or where the first application is a map application and the second application is a game application.

Still further embodiments of such a method may include establishing, based on the first request a first secure data connection to the first H-SLP or establishing, based on the second request a second secure data connection to the second H-SLP.

Additional embodiments of such a method may function where the first secure data connection and the second secure data connection are open simultaneously or where the first secure data connection is terminated before the second secure data connection is established.

Additional embodiments of such a method may include initiating, by a third application operating on the SET, a third request for SUPL service. Additional embodiments of such a method may include identifying in the application identifier list, that the second FQDN is associated with the third application; and communicating, by the SET, the third request for SUPL service to the second H-SLP associated with the second FQDN. Additional embodiments of such a method may include identifying in the application identifier list, a third FQDN associated with the third application, wherein the third FQDN is different than the first FQDN and the second FQDN and wherein the application identifier list further comprises the third FQDN; and communicating, by the SET, the third request for SUPL service to a third H-SLP associated with the third FQDN.

Additional embodiments of such a method may include provisioning a first application identification group for a secure user plane location enabled terminal (SET) that associates a first fully qualified domain name (FQDN) of a first home Secure User Plane Location Platform (H-SLP) with a first application, such that the first application initiates communication with the first H-SLP to request location services; and provisioning, for the SET, a second application identification group that associates a second FQDN of a second H-SLP with a second application, such that the second application initiates communication with the second H-SLP to request location services; where the second FQDN is different than the first FQDN; and where the second H-SLP is different than the first H-SLP. Additional embodiments of such a method may function where the first application identification group comprises an ID number associated with the first application; and where the second application identification group comprises an ID number associated with the second application. Additional embodiments of such a method may function where the first application identification group further comprises an ID number associated with a third application.

Additional embodiments of such a method may include provisioning, for the SET, a third application identification group that associates a third FQDN of a third H-SLP with a third application, such that the third application initiates communication with the third H-SLP to request location services; where the third FQDN is different than the first FQDN and the second FQDN.

Additional embodiments of such a method may include executing the first application on the SET; initiating a first request for secure user plane location (SUPL) service; identifying the ID number associated with the first application in the first application identification group; and communicating, by the SET, the first request for SUPL service to the first H-SLP associated with the first FQDN.

Additional embodiments of such a method may include receiving, at the SET, a third application; identifying that the third application has a capability to request location services from the first FQDN; and adding an ID associated with the third application to the first application identification group.

An alternate embodiment may be implemented as a device. One potential example of such a device may include a processor and a non-transitory computer readable storage medium. The medium may store a plurality of application identifiers and a plurality of fully qualified domain names (FQDN), wherein each application identifier of the plurality of application identifiers is associated with a FQDN. In such an embodiment of a device, the computer readable storage medium further comprises a set of instructions that are executable by the processor to create a first secure plane location service request associated with a first application identifier of the plurality of application identifiers and to communicate the first secure plane location request to a first home secure user plane location platform using a first FQDN of the plurality of FQDNs, and to create a second secure user plane location service request associated with a second application identifier of the plurality of application identifiers and to communicate the second secure plane location request to a second home secure location server platform using a second FQDN of the plurality of FQDNs.

An alternate embodiment may be implemented as a networked server computer. Such an embodiment may be a secure user plane location platform enabled terminal (SET) that is made up of means for contacting a first home Secure User Plane Location (H-SLP), such that a first application of the SET communicates with a first H-SLP to request and receive location services and means for contacting a second H-SLP with a second application, such that the second application communicates with the second H-SLP to request location services, where the first H-SLP is different than the first H-SLP.

An alternate embodiment may be implemented as a non-transitory computer readable instruction medium comprising instructions that, when executed by a processor, implement a method comprising initiating, by a first application operating on a secure user plane location enabled terminal (SET), a first request for secure user plane location (SUPL) service and identifying in an application identifier list, a first fully qualified domain name (FQDN) associated with the first application. In such an embodiment, the method further comprises communicating, by the SET, the first request for SUPL service to a first H-SLP associated with the first FQDN; initiating, by a second application operating on the SET, a second request for SUPL service; identifying in the application identifier list, a second FQDN associated with the second application, wherein the second FQDN is different than the first FQDN and wherein the application identifier list comprises the first FQDN and the second FQDN; and communicating, by the SET, the second request for SUPL service to a second H-SLP associated with the second FQDN.

Alternative implementations of such an embodiment may further include instructions where the method also comprises establishing, based on the second request a second secure data connection to the second H-SLP, wherein the first secure data connection is terminated before the second secure data connection is established.

Further alternative implementations may include instructions where the method additionally comprises initiating, by a third application operating on the SET, a third request for SUPL service; identifying in the application identifier list, that the second FQDN is associated with the third application; and communicating, by the SET, the third request for SUPL service to the second H-SLP associated with the second FQDN.

Additional embodiments will be apparent to one of ordinary skill in the art based on the example embodiments above as well as the descriptions and additional embodiments included throughout.

### BRIEF DESCRIPTION OF THE DRAWINGS

Aspects of the disclosure are illustrated by way of example. In the accompanying figures, like reference numbers indicate similar elements, and:

FIG. 1 illustrates a simplified diagram of a system implementing a known system for accessing an H-SLP;

FIG. 2 illustrates a simplified diagram of an apparatus according to one or more embodiments;

FIG. 3 illustrates a simplified diagram of an apparatus according to one or more embodiments;

FIG. 4 illustrates a method according to one or more embodiments;

FIG. 5 illustrates aspects of a mobile device that may operate in accordance with one or more embodiments;

FIG. 6 illustrates a method implementing one or more embodiments;

FIG. 7 illustrates one potential embodiment of a computing device that may be used with aspects of one or more embodiments of various systems and devices.

### DETAILED DESCRIPTION

Aspects of the disclosure relate to computing technologies which enable location services. In particular, aspects of the disclosure relate to systems, methods, apparatus, and computer readable media for selecting one of a plurality of home Secure User Plane Location (SUPL) Platform (H-SLP) servers for providing location services in conjunction with various applications running on a device.

For example, in one potential embodiment a user's mobile phone may operate multiple applications. Certain applications may request location services. Rather than all applications requesting location services via the same H-SLP server, each application may instead be associated with a particular H-SLP, such that a first application may request location services from one H-SLP, and a second application running on the same mobile device may request location services from a second, different H-SLP.

Such a system may reduce loads on H-SLP servers by distributing load to other SLP servers. Such a system may enable certain applications to access location information more efficiently from service providers more closely associated with particular information that is of greater use to certain applications than other applications. Such embodiments may further enable security, cost, and infrastructure efficiencies by allowing location services to be more closely tailored to specific applications. In situations where location services provided by SLP servers may involve multiple steps from H-SLP servers to other SLP servers, efficiencies may be gained by making certain servers H-SLP servers for certain applications, where the servers would be treated as discovered, or lower tier SLP servers in other situations.

SUPL is an internet protocol (IP) based standard for position location using positioning technologies such as global navigation satellite system (A-GNSS), observed time difference of arrival (OTDOA), enhanced cell ID (E-CID), advanced forward link trilateration (AFLT), or any other locating system. over IP (i.e. user plane). An SLP is a SUPL Location Platform, which may essentially be a computing system to provide assistance data to a SUPL Enabled Terminal (SET) and positioning calculation capabilities (using positioning measurements performed by the SET and sent to the SLP) in order to determine the location of a SET. A SET is a device that supports SUPL capabilities, i.e., that may be located using a SUPL system. A Home SLP (H-SLP) is the SLP that provides location services and receives initial requests for a SUPL session from particular SET. In prior art systems, an H-SLP is primarily responsible for providing SLP location services to a particular SET. An H-SLP may also communicate with other SLPs such as Discovered SLPs (D-SLP) or Visited SLPs (V-SLP) to coordinate services. D-SLPs and V-SLPs are SLPs able to provide service to a SET in areas where the H-SLP may be unable to provide service or unable to provide service at the requested quality of service (accuracy, time to fix, etc.) Further details and description for each of these terms will be provided along with additional details related to various embodiments of the presented innovations.

The basic function of an H-SLP is to provide service (assistance data delivery and/or position calculation) to a SET communicating over IP. In certain areas, however, an H-SLP may have limited ability to communicate with the SET. Examples may be indoor locations or locations where a third party has important information that the H-SLP may not have access to. In such environments a D-SLP may be used to provide improved (localized) location service to a SET. The D-SLP may be operated by the same entity operating the H-SLP or it may be operated by a 3^{rd} party. An H-SLP may negotiate with a D-SLP to allow a SET to have access to the D-SLP as part of a business relationship between the H-SLP and the D-SLP. When a SET discovers a D-SLP, the SET may query its H-SLP for access rights to that D-SLP (type of service allowed, service area, service time window, etc.) through an authorization process.

FIG. 1 describes a prior art H-SLP service provided to SET 120. FIG. 1 includes SET 120 and H-SLP 110. H-SLP 110 is associated with a fully qualified domain name (FQDN) 114 and may operate multiple SUPL sessions 112 in communication with one or more SETs. SETs communicate with H-SLP 110 using SUPL user plane location protocol (ULP) Signaling 130. SETs involved in such communications may operate a plurality of applications 121, and may further interact with H-SLP 110 as part of any number of SUPL sessions 122 which are initiated by corresponding applications 121 operating on SET 120. SET 120 may additionally operate any number of operations which do not request location services, but applications 121 are applications that request location services. As used herein a FQDN or fully qualified domain name is a domain name that specifies the exact location of a file or object within the tree hierarchy of the Domain Name System (DNS) that operates on the Internet or any network using DNS. In certain embodiment systems, and identifier that may enable a SET to identify and access a server may function in place of a FQDN or a FQDN may be any such identifier.

In FIG. 1, SET 120 has a fixed H-SLP allocation based on a pre-provisioned FQDN 114 which may reside in a secure location on SET 120, on a universal integrated circuit card (UICC), or in any other acceptable memory storage used by SET 120 for FQDN storage. SET 120 uses the pre-provisioned FQDN 114 to establish a secure data connection to the H-SLP 110 when engaging in a SET Initiated (SI) SUPL session 122. A location service request by SET resident applications 121 results in a SI SUPL session 122 with the pre-provisioned H-SLP. Multiple such applications with corresponding sessions are shown a SUPL sessions 122A-N and applications 121A-N. In the prior art system of FIG. 1, there is no mechanism to allow different applications 121 (e.g., a social networking application, a map application, a game application, etc.) to use different H-SLPs other than H-SLP 110. As a result, a single H-SLP 110 operated by a single SUPL service provider provides service for all SET 120 resident applications 121. This mechanism allows a single H-SLP to either grant or deny SUPL service based on the requesting application's identity (application id) which is signaled by the SET to the H-SLP during SUPL session establishment. The mechanism does not allow different applications to use different H-SLPs. Services required by SET 120 from SLPs other than H-SLP 110 must be coordinated via H-SLP 110 interacting with other SLPs as, for example, in the case of D-SLP interactions

FIGS. 2 and 3 describe embodiments whereby a system may access multiple H-SLPs. FIG. 2 includes application identification groups 225A-N communicating with corresponding H-SLPs 210A-N using corresponding FQDNs 214A-N. In an embodiment according to FIG. 2, the SUPL service structure may be altered by provisioning the SET or UICC with multiple H-SLPs 210 using a structure with groups of application ids. Each application that may operate on a SET may be assigned a unique identifier (ID). Each application ID group 225 may be associated with a single H-SLP of H-SLPs 210, and each application ID can only be part of one single application id group of application identification groups 225.

FIG. 3 provides an additional embodiment showing a system where a SET may access different H-SLPs. FIG. 3 shows SET 320 and multiple different H-SLPs 310A-N. SET 320 may function with applications 321P-Z. Applications 321P-Z may be grouped into application identification groups. In FIG. 3, applications 321P and 321Q are shown as part of application identification group 325A, application 321R is shown as part of application identification group 325B, and application 321Z is shown as part of application identification group 325N. In various alternative embodiments, an application identification group may include any number of application identifiers associated with various applications. Additionally, in certain embodiments, a particular application identification group may include only one application ID. In certain embodiments, an application ID group may include no application identifiers if all applications for a particular group and the associated identifiers have been removed from the system, but the system wants to retain a record of a FQDN for which there is no currently assigned application ID.

As part of the operation of SET 320, each application 321 may initiate and maintain a SUPL session 322. In various embodiments, certain applications may not have the capability to request location server, and certain may have this capability. Application ID groups may only include IDs for applications with known capability for initiating SUPL sessions, or all applications on a SET 320 may have an application ID which is associated with an application ID group. In any event, when a SUPL session 322 is open, the system engages in SUPL signaling 330 with the corresponding H-SLP 310. As shown, applications 321P and 321Q communicate with H-SLP 310A, application 321R communicates with H-SLP 310B, and application 321Z interacts with H-SLP 310N.

Thus, whereas in previous systems using SUPL services only a single H-SLP was used. For example, H-SLP 310A may have been the single H-SLP for SET 320, with access to information from H-SLP 310B-N obtained using D-SLPs or other means via H-SLP 310A, the system of FIG. 3 allows applications to be associated with the most relevant H-SLP and to potentially eliminate communications with intermediate H-SLP servers. In certain embodiments, applications are associated with an H-SLP run by or associated with the creator of the application. Thus, instead of devices having service rights to a single H-SLP, applications may have service rights to different H-SLPs, with a first application having rights to a first H-SLP but not a second H-SLP, and a second application having rights to the second H-SLP but not the first H-SLP. This provides an improvement over system functionality where a device with a single H-SLP must pass all location service requests through a single H-SLP, regardless of the access rights or associations of the application requesting the location services.

FIG. 4 describes one potential method of implementing an embodiment. In S410, a first application such as application 321P of FIG. 3 may create a first request for SUPL service. Examples of this may be a map application requesting a current location for the purpose of providing directions, a social networking application requesting a current location for the purposes of identifying other nearby devices, or a game application requesting location or movement information related to aspects of the game being played on the device via the application.

In S420, the SET identifies a first H-SLP associated with the first application. This identification may be done by looking up an application ID in a table to find an associated H-SLP and FQDN, by identifying an application ID group, or by any other such similar means. Identification of the first H-SLP may further involve accessing a secure memory in embodiments where a FQDN for an H-SLP is stored using security measures. In S430, the SET then communicates the first request for SUPL service to the first H-SLP. Just as the FQDN may be stored using security measures, the communication from the SET to the H-SLP may be done as part of a secure communication, with any subsequent SUPL session being implemented as part of secure communications. Such security precautions may be implemented to protect privacy of a user's location, and to prevent third parties from accessing location services which may have associated limits or charges/costs.

In S440, similar to S410 above, a second application operating on the SET creates a second request for SUPL service. In various embodiments, the request may be during a SUPL session initiated by the first application or any other application, or may be after a previous session has been terminated. The second request may use a similar process for creating the request as the first request, or may use an alternative method, as long as the request is for an H-SLP that is different than the first H-SLP.

In S450, the SET identifies the second H-SLP that is different than the first H-SLP. Just as with the first H-SLP, this may be done using an associated group ID, a FQDN lookup in a table or chart, or using any other such means. In certain embodiments, applications may receive updates that are downloaded to a SET that may create, update, or alter an H-SLP and/or FQDN that is associated with a particular ID. Part of this update may include an update to the portions of the system that the SET uses to identify an H-SLP associated with an application identifier. In alternative embodiments, a SET may update associations or application ID groups following such an update. Similarly, certain applications may be provisioned during initial set-up of a SET, and application ID groups or associations of applications with multiple H-SLPs may occur during this initial set-up or provisioning.

In S460, then, the SET communicates the second request for SUPL service to the second H-SLP. Just as above, this may be done using a securely stored FQDN and/or secure sessions with the second H-SLP in order to provide location services to the SET from a second H-SLP after location services have been received from the first H-SLP. In certain embodiments, this may also take place concurrently.

While the method of FIG. 4 describes two different applications requesting location services from two different H-SLPs, further embodiments may include any number of applications requesting service from any number of H-SLPs. For example, a third application may, subsequent to the method described in FIG. 4. request location services from a third H-SLP different than both the first and second H-SLPs, and a fourth application may then request services from the second H-SLP.

FIG. 5 is block diagram illustrating one potential embodiment of a mobile device that may be used in conjunction with embodiments described herein. Such mobile devices may be provisioned to access a plurality of H-SLP servers to access different sources of location services for a mobile device. The system may be a mobile device 500, which may be any mobile device such as a smart phone, cellular phone, personal digital assistant, tablet computer, personal media player as well as any other type of portable electronic device offering similar or combined functionality. It should be appreciated that device 500 may also include tactile buttons, a power device (e.g., a battery), as well as other components typically associated with a portable electronic device. Accordingly, FIG. 5 is not to be construed as limiting because some components are omitted.

In the embodiment shown at FIG. 5, device 500 includes processor 510 configured to execute instructions for performing operations at a number of components and can be, for example, a general-purpose processor or microprocessor suitable for implementation within a portable electronic device. Processor 510 is communicatively coupled with a plurality of components within mobile device 500. To realize this communicative coupling, processor 510 may communicate with the other illustrated components across a bus 540. Bus 540 can be any subsystem adapted to transfer data within mobile device 500. Bus 540 can be a plurality of computer buses and include additional circuitry to transfer data.

Memory 520 may be coupled to processor 510. In some embodiments, memory 520 offers both short-term and long-term storage and may in fact be divided into several units. Memory 520 may be volatile, such as static random access memory (SRAM) and/or dynamic random access memory (DRAM) and/or non-volatile, such as read-only memory (ROM), flash memory, and the like. Furthermore, memory 520 can include removable storage devices, such as secure digital (SD) cards. Thus, memory 520 provides storage of computer readable instructions, data structures, program modules, and other data for mobile device 500. In some embodiments, memory 520 may be distributed into different hardware modules.

In some embodiments, memory 520 may include a secure memory 520A as part of memory 520. Such secure memory 520A may be encrypted, secured with a hardware key, or kept secure in any similar or combination fashion. In other embodiments, secure memory 520A may be a separate memory device. Such a secure memory may be used to store sensitive portions of data for applications, or to store communication information such as FQDN information for H-SLP servers to be accessed by one or more applications.

In some embodiments, memory 520 stores a plurality of application modules 521-522. Application modules 521-522 contain particular instructions to be executed by processor 510. Memory 520 can store any number of application modules. A respective one of application modules 521-522 can be, for example, a calendar application, a geo-fencing application, a power management application, a smart alert application, a social media application (e.g., Twitter™ or Facebook™), or any application-type module having instructions to be executed by processor 510. Any such applications may access location services including services provided by an H-SLP. Additional applications may be map applications, game applications, or social networking applications that access location services using different H-SLPs identified by application identification groups according to various embodiments.

In some embodiments, memory 520 includes an operating system 523. Operating system 523 may be operable to initiate the execution of the instructions provided by application modules 521-522 and/or manage hardware modules 501-502. Operating system 523 may be adapted to perform other operations across the components of device 500 including threading, resource management, data storage control and other similar functionality.

In some embodiments, mobile device 500 includes one or more wireless modules 512. Wireless modules 512 may include a Wi-Fi transceiver, a transceiver for communicating with cellular telephone towers, or any other such module for implementing wireless communications. Such wireless modules 512 may be used as part of mobile device 500 and applications 501-502 to communicate with servers providing location services, and to communicate requests for location services to H-SLP servers and FQDNs stored in a memory of mobile device 500.

Additionally, in some embodiments, mobile device 500 includes a plurality of hardware modules 501-502. Each of hardware modules 501-502 is a physical module within device 500. However, while each of hardware modules 501-502 is permanently configured as a structure, a respective one of hardware modules 501-502 may be temporarily configured to perform specific functions or temporarily activated. A common example is an application module that may program a camera module (i.e., hardware module) for shutter release and image capture. A respective one of hardware modules 501-502 can be, for example, an accelerometer, a satellite navigation system receiver (e.g., a GPS module), a pressure module, a temperature module, an audio output and/or input module (e.g., a microphone), a camera module, a proximity sensor, an alternate line service (ALS) module, a capacitive touch sensor, a near field communication (NFC) module, a Bluetooth transceiver, a cellular transceiver, a magnetometer, a gyroscope, an inertial sensor (e.g., a module the combines an accelerometer and a gyroscope), an ambient light sensor, a relative humidity sensor, or any other similar module operable to provide sensory output and/or receive sensory input. In some embodiments, one or more functions of the hardware modules 501-502 may be implemented in software.

In addition to hardware modules 501-502 and application modules 521-522, mobile device 500 may have a display module 503 and a user input module 504. Display module 503 graphically presents information from device 500 to the user. This information may be derived from one or more application modules 521-522, one or more hardware modules 501-502, a combination thereof, or any other suitable means for resolving graphical content for the user (e.g., by operating system 524). Display module 503 can be liquid crystal display (LCD) technology, light emitting polymer display (LPD) technology, or some other display technology. In some embodiments, display module 503 is a capacitive or resistive touch screen and may be sensitive to haptic and/or tactile contact with a user. In such embodiments, the display module 503 can comprise a multi-touch-sensitive display.

Additional embodiments of a mobile device may further comprise various portions of computing devices as are detailed below with respect to FIG. 7.

FIG. 6 is a flowchart describing one potential embodiment. After the start of the method of FIG. 6, an application initially requests location service at S602. In response to this request, the SET attempts to determine an application ID in S604. In S606, the SET determines if an application ID exists. If the ID exists, the method proceeds to S608. If the ID does not exist, the method proceeds to S618 whereby a default FQDN is used to establish SUPL location services.

In S608, after an application ID is determined to exist, the application ID group that the application ID is associated with is determined, and in S610, the H-SLP and FQDN associated with the appropriate application ID group is selected. In S612, the SET determines whether or not the H-SLP exists. This may be done by communicating an initial request to the FQDN to initiate a session, by checking an update list or a list of known acceptable H-SLPs, or by any other means. If no response is received to a request for services, or if the selected H-SLP associated with the application ID is not acceptable or available for any reason, then the method proceeds to S618 again, and defaults to the SETs default H-SLP. If the selected FQDN does exist and is acceptable, then a SUPL session is established with this selected H-SLP that is different than the default H-SLP. The method then proceeds with execution of the SUPL session in S616 for the location services from the non-default H-SLP.

In either case, whether the default H-SLP server is used in S618 and S620, or if the non-default H-SLP is used in S614 and S616, the method may be run again either following the end of SUPL services from whichever H-SLP is used, or the method may be run multiple times concurrently to enable SUPL services from different H-SLPs to different applications on a single SET to have concurrent sessions.

Additionally, while the embodiment of FIG. 6 describes an application where either a default or a non-default H-SLP may be used, further embodiments may involve additional non-default H-SLPs for additional applications that may have concurrent sessions with different H-SLPs.

FIG. 7 illustrates an example of a computing system in which one or more embodiments may be implemented. A computer system as illustrated in FIG. 7 may be incorporated as part of the previously described computerized devices in other figures. FIG. 7 provides a schematic illustration of one embodiment of a computer system 700 that can perform the methods provided by various other embodiments, as described herein, and/or can function for example as SET 320 or H-SLP 310A-N of FIG. 3. In various alternative embodiments of a mobile device, certain elements of FIG. 7 may be integrated or interchanged with elements of FIG. 5. FIG. 7 is meant only to provide a generalized illustration of various components, any or all of which may be utilized as appropriate. FIG. 7, therefore, broadly illustrates how individual system elements may be implemented in a relatively separated or relatively more integrated manner.

The computer system 700 is shown comprising hardware elements that can be electrically coupled via a bus 705 (or may otherwise be in communication, as appropriate). The hardware elements may include one or more processors 710, including without limitation one or more general-purpose processors and/or one or more special-purpose processors (such as digital signal processing chips, graphics acceleration processors, and/or the like); one or more input devices 715, which can include without limitation a mouse, a keyboard and/or the like; and one or more output devices 720, which can include without limitation a display device, a printer and/or the like.

The computer system 700 may further include (and/or be in communication with) one or more non-transitory storage devices 725, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 700 might also include a communications subsystem 730, which can include without limitation a modem, a network card (wireless or wired), an infrared communication device, a wireless communication device and/or chipset (such as a Bluetooth™ device, an 702.11 device, a Wi-Fi device, a WiMax device, cellular communication facilities, etc.), and/or similar communication interfaces. The communications subsystem 730 may permit data to be exchanged with a network (such as the network described below, to name one example), other computer systems, and/or any other devices described herein. In many embodiments, the computer system 700 will further comprise a non-transitory working memory 735, which can include a RAM or ROM device, as described above.

The computer system 700 also can comprise software elements, shown as being currently located within the working memory 735, including an operating system 740, device drivers, executable libraries, and/or other code, such as one or more application programs 745, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 725 described above. In some cases, the storage medium might be incorporated within a computer system, such as computer system 700. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Moreover, hardware and/or software components that provide certain functionality can comprise a dedicated system (having specialized components) or may be part of a more generic system. For example, an activity selection subsystem configured to provide some or all of the features described herein relating to the selection of activities by a context assistance server 140 can comprise hardware and/or software that is specialized (e.g., an application-specific integrated circuit (ASIC), a software method, etc.) or generic (e.g., processor(s) 710, applications 745, etc.) Further, connection to other computing devices such as network input/output devices may be employed.

Some embodiments may employ a computer system (such as the computer system 700) to perform methods in accordance with the disclosure. For example, some or all of the procedures of the described methods may be performed by the computer system 700 in response to processor 710 executing one or more sequences of one or more instructions (which might be incorporated into the operating system 740 and/or other code, such as an application program 745) contained in the working memory 735. Such instructions may be read into the working memory 735 from another computer-readable medium, such as one or more of the storage device(s) 725. Merely by way of example, execution of the sequences of instructions contained in the working memory 735 might cause the processor(s) 710 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 700, various computer-readable media might be involved in providing instructions/code to processor(s) 710 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 725. Volatile media include, without limitation, dynamic memory, such as the working memory 735. Transmission media include, without limitation, coaxial cables, copper wire and fiber optics, including the wires that comprise the bus 705, as well as the various components of the communications subsystem 730 (and/or the media by which the communications subsystem 730 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700. These signals, which might be in the form of electromagnetic signals, acoustic signals, optical signals and/or the like, are all examples of carrier waves on which instructions can be encoded, in accordance with various embodiments.

The communications subsystem 730 (and/or components thereof) generally will receive the signals, and the bus 705 then might carry the signals (and/or the data, instructions, etc. carried by the signals) to the working memory 735, from which the processor(s) 705 retrieves and executes the instructions. The instructions received by the working memory 735 may optionally be stored on a non-transitory storage device 725 either before or after execution by the processor(s) 710.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of various embodiments. Rather, the preceding description of the embodiments will provide those skilled in the art with an enabling description for implementing embodiments. Various changes may be made in the function and arrangement of elements without departing from the spirit and scope of various embodiments.

Also, some embodiments were described as processes depicted in a flow with process arrows. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application various embodiments. Also, a number of steps may be undertaken before, during, or after the above elements are considered. Accordingly, the above description does not limit the scope of the disclosure.

What is claimed is:

1. A method comprising:
initiating, by a first application operating on a secure user plane location enabled terminal (SET), a first request for secure user plane location (SUPL) service;
identifying in an application identifier list, a first fully qualified domain name (FQDN) associated with the first application;
communicating, by the SET, the first request for SUPL service to a first home SUPL server (H-SLP) associated with the first FQDN;
initiating, by a second application operating on the SET, a second request for SUPL service;
identifying in the application identifier list, a second FQDN associated with the second application, wherein the second FQDN is different than the first FQDN and wherein the application identifier list comprises the first FQDN and the second FQDN; and
communicating, by the SET, the second request for SUPL service to a second H-SLP associated with the second FQDN.

2. The method of claim 1 wherein the first and the second FQDN are stored in a secure location on the SET.

3. The method of claim 1 wherein the first and the second FQDN are stored on a universal integrated circuit card (UICC) used by the SET.

4. The method of claim 1 further comprising:
establishing, based on the first request, a first secure data connection to the first H-SLP.

5. The method of claim 4 wherein the first application is a map application and the second application is a game application.

6. The method of claim 4 further comprising:
establishing, based on the second request a second secure data connection to the second H-SLP.

7. The method of claim 6 wherein the first secure data connection and the second secure data connection are open simultaneously.

8. The method of claim 6 wherein the first secure data connection is terminated before the second secure data connection is established.

9. The method of claim 7 further comprising:
initiating, by a third application operating on the SET, a third request for SUPL service.

10. The method of claim 9 further comprising:
identifying in the application identifier list, that the second FQDN is associated with the third application; and
communicating, by the SET, the third request for SUPL service to the second H-SLP associated with the second FQDN.

11. The method of claim 9 further comprising:
identifying in the application identifier list, a third FQDN associated with the third application, wherein the third FQDN is different than the first FQDN and the second FQDN and wherein the application identifier list further comprises the third FQDN; and
communicating, by the SET, the third request for SUPL service to a third H-SLP associated with the third FQDN.

12. A method comprising:
provisioning a first application identification group for a secure user plane location enabled terminal (SET) that associates a first fully qualified domain name (FQDN) of a first home Secure User Plane Location Platform (H-SLP) with a first application, such that the first application initiates communication with the first H-SLP to request location services; and
provisioning, for the SET, a second application identification group that associates a second FQDN of a second H-SLP with a second application, such that the second application initiates communication with the second H-SLP to request location services;
wherein the second FQDN is different than the first FQDN; and
wherein the second H-SLP is different than the first H-SLP.

13. The method of claim 12 wherein the first application identification group comprises an ID number associated with the first application; and
wherein the second application identification group comprises an ID number associated with the second application.

14. The method of claim 13 wherein the first application identification group further comprises an ID number associated with a third application.

15. The method of claim 13 further comprising:
provisioning, for the SET, a third application identification group that associates a third FQDN of a third H-SLP with a third application, such that the third application initiates communication with the third H-SLP to request location services;
wherein the third FQDN is different than the first FQDN and the second FQDN.

16. The method of claim 13 further comprising:
executing the first application on the SET;
initiating a first request for secure user plane location (SUPL) service;
identifying the ID number associated with the first application in the first application identification group; and
communicating, by the SET, the first request for SUPL service to the first H-SLP associated with the first FQDN.

17. The method of claim 13 further comprising:
receiving, at the SET, a third application;
identifying that the third application has a capability to request location services from the first FQDN; and
adding an ID associated with the third application to the first application identification group.

18. A device comprising:
a processor;
a non-transitory computer readable storage medium that stores a plurality of application identifiers and a plurality of fully qualified domain names (FQDN), wherein each application identifier of the plurality of application identifiers is associated with a FQDN;
wherein the computer readable storage medium further comprises a set of instructions that are executable by the processor to create a first secure plane location service request associated with a first application identifier of the plurality of application identifiers; to communicate the first secure plane location request to a first home secure user plane location platform (H-SLP) using a first FQDN of the plurality of FQDNs; to create a second secure user plane location service request associated with a second application identifier of the plurality of application identifiers; and to communicate the second secure plane location request to a second H-SLP using a second FQDN of the plurality of FQDNs.

19. The device of claim 18 wherein the computer readable storage medium further comprises additional instructions that are executable by the processor to:
establish, based on the first secure plane location service request, a first secure data connection to the first H-SLP;
establish, based on the second secure plane location request, a second secure data connection to the second H-SLP; and
initiate, by a third application operating on the device, a third request for SUPL service.

20. The device of claim 19 wherein the computer readable storage medium further comprises additional instructions that are executable by the processor to:
identify in an application identifier list, that the second FQDN is associated with the third application; and
communicate, by the device, the third request for SUPL service to the second H-SLP associated with the second FQDN.

21. A secure user plane location platform enabled terminal (SET) comprising:
means for contacting a first home Secure User Plane Location (H-SLP), such that a first application of the SET communicates with a first H-SLP to request and receive location services; and
means for contacting a second H-SLP with a second application, such that the second application communicates with the second H-SLP to request location services;
wherein the first H-SLP is different than the first H-SLP.

22. The SET of claim 21 further comprising:
means for establishing, based on the communication with the first H-SLP, a first secure data connection to the first H-SLP;
means for establishing, based on the communication with the second H-SLP a second secure data connection to the second H-SLP; wherein the first secure data connection and the second secure data connection are open simultaneously.

23. The SET of claim 22 further comprising:
means for identifying in an application identifier list, a first fully qualified domain name (FQDN) associated with the first application and a second FQDN associated with the second application;
means for initiating, by a third application operating on the SET, a third request for SUPL service;
means for identifying in the application identifier list, a third FQDN associated with the third application, wherein the third FQDN is different than the first FQDN and the second FQDN and wherein the application identifier list further comprises the third FQDN; and
means for communicating, by the SET, the third request for SUPL service to a third H-SLP associated with the third FQDN.

24. A non-transitory computer readable instruction medium comprising instructions that, when executed by a processor, implement a method comprising:
initiating, by a first application operating on a secure user plane location enabled terminal (SET), a first request for secure user plane location (SUPL) service;
identifying in an application identifier list, a first fully qualified domain name (FQDN) associated with the first application;
communicating, by the SET, the first request for SUPL service to a first home SUPL server (H-SLP) associated with the first FQDN;
initiating, by a second application operating on the SET, a second request for SUPL service;
identifying in the application identifier list, a second FQDN associated with the second application, wherein the second FQDN is different than the first FQDN and wherein the application identifier list comprises the first FQDN and the second FQDN; and
communicating, by the SET, the second request for SUPL service to a second H-SLP associated with the second FQDN.

25. The non-transitory computer readable instruction medium of claim 24 wherein the method further comprises:
establishing, based on the second request a second secure data connection to the second H-SLP, wherein the first secure data connection is terminated before the second secure data connection is established.

26. The non-transitory computer readable instruction medium of claim 24 wherein the method further comprises:
initiating, by a third application operating on the SET, a third request for SUPL service;
identifying in the application identifier list, that the second FQDN is associated with the third application; and
communicating, by the SET, the third request for SUPL service to the second H-SLP associated with the second FQDN.
